(19) United States
(12) Patent Application Publication
(10) Pub. No.: US 2011/0148569 A1
(43) Pub. Date: Jun. 23, 2011

(54) METHOD FOR GAP CHARACTERIZATION IN INDUCTIVELY COUPLED ACCESS SYSTEMS

(76) Inventor: Herbert Froitzheim, Pettendorf (DE)

(21) Appl. No.: 12/524,336

(22) PCT Filed: Jan. 22, 2008
(86) PCT No.: PCT/EP08/50717

§ 371 Date: Nov. 11, 2009

(30) Foreign Application Priority Data
Jan. 24, 2007 (DE) 10 2007 003 495.6

(51) Int. Cl. G08B 29/00

(52) U.S. Cl. 340/5.7

(57) ABSTRACT

An access facility for a vehicle has a first transmit/receive device for transmitting a first radio signal and for receiving a second radio signal, a second transmit/receive device for transmitting the second radio signal and receiving the first radio signal, a transmission strength determining device for determining a transmission strength value, which represents the transmission field strength of the first radio signal transmitted by the first transmit/receive device, and a reception strength determining device for determining a second reception strength value, which represents the reception field strength of the first radio signal at the location of the second transmit/receive device. The information content of the first radio signal has the transmission strength value, and the access facility features a relation determining device for determining a relation between the transmission strength value and the reception strength value.

### CROSS-REFERENCE TO RELATED APPLICATIONS

This application is a U.S. National Stage Application of International Application No. PCT/EP2008/050717 filed Jan. 22, 2008, which designates the United States of America, and claims priority to German Application No. 10 2007 003 495.6 filed Jan. 24, 2007, the contents of which are hereby incorporated by reference in their entirety.

### TECHNICAL FIELD

The invention relates to the control of an access facility for a vehicle.

### BACKGROUND

In modern access authorization systems or access control systems, increasing use is made of electronic security systems or access facilities wherein the authentication of a person having access authorization takes place by means of data communication between a first communication device, which is usually arranged at the access object, and a second communication device that is held by the person having access authorization. In terms of the security systems, a distinction is made between active access facilities and passive access facilities.

In the case of an active access facility, an identification code is sent from the second communication device to the first communication device, which is arranged e.g. in a vehicle.

This can be achieved by pressing a button on a mobile identification generator, for example. The identification code is checked in the second communication device and, if successful, the locking apparatus of the access facility can be disengaged or engaged. Because the identification generator must be deliberately operated by its owner, i.e. in order to allow the owner access to the motor vehicle, this electronic access system is known as an active access system.

In the case of a passive access facility, the first communication device transmits request signals having a specific field strength, either at regular intervals or when a device is operated, e.g. the door handle of a vehicle is pulled or its starter button is operated. If the second communication device is situated within the effective range of the first communication device, it can receive these request signals and reply to them in order to initiate an authentication process or pre-authentication process. The authentication takes place via an exchange of data telegrams, which also send the authentication code from the second communication device to the first communication device. If the authentication is successful, the locking apparatus that was secured by the access facility is disengaged and can then be opened automatically or manually. Because the identification generator in the present case does not have to be deliberately operated by its owner, this electronic access system is known as a passive access system, in contrast with the system explained previously. Passive access systems are also known as keyless vehicle access systems.

The request signal is usually broadcast in the inductive frequency range, using an LF transmitter (low-frequency transmitter) which operates in the kHz range, and is received by the LF receiver of the second communication device. The received request signal is decoded and processed to produce a reply signal, which is transferred from the second communication device, using an HF transmitter (high-frequency transmitter) that usually operates with a modest transmission power in the MHz range, to the HF transmit/receive device of the first communication device.

The transmission of the LF request signal is referred to as a wake-up. The rapidly decreasing magnetic field of the request signal that is transmitted by the first communication device limits the effective range of the access facility to a functional radius of typically less than ten meters.

In order to ensure that only the user seeking identification gains access, the disengagement of the locking apparatus can be made dependent on the gap between first and second communication device. For example, the effective range of the access facility is divided into three zones: the detection zone, whose outer limit corresponds to the limit of the effective range, the access zone and the interior zone. If the user enters the detection zone, the second communication device receives the request signal. In the authentication zone, approximately one meter closer to the locking apparatus that is secured by the access facility, the second communication device transmits the reply signal. If the user then enters the access zone, which is generally the region of one meter around the locking apparatus, said locking apparatus is then disengaged.

The determination of the gap between first and second communication device of the access facility currently takes place by determining the field strength with which the request signal is received at the second communication device. However, the use of the reception field strength as a measure for the gap between the two communication devices presupposes that the request signal is broadcast using a preset power or field strength. For this, either the supply current or the supply voltage of the antenna of the first communication device is set to a predetermined value. The setting of the transmission field strength is either done by actuating elements, which can be regulated or controlled, or is permanently predetermined by the design of the device. It is noted that, in contrast with the normal use of language, the terms regulate and control are not differentiated in this document. Instead, both terms are used synonymously, i.e. the term control can encompass feedback of a regulating variable or its measured value, and the term regulate can relate to a simple open-loop control system. This also relates to grammatical derivations of these terms. However, the dissipated power of the actuating elements considerably increases the energy consumption of the first communication device.

### SUMMARY

Taking this as its starting point, according to various embodiments an access facility can be specified which allows reliable characterization of the gap between first and second communication device at the same time as reduced energy consumption.

According to an embodiment an access facility for a vehicle, may comprise a first transmit/receive device for transmitting a first radio signal and receiving a second radio signal, a second transmit/receive device for transmitting the second radio signal and receiving the first radio signal, a transmission strength determining device for determining a transmission strength value, which represents the transmission field strength of the first radio signal transmitted by the first transmit/receive device, and a reception strength determining device for determining a second reception strength value, which represents the reception field strength of the first radio signal at the location of the second transmit/receive device, wherein the information content of the first radio signal comprises the transmission strength value, and the access facility features a relation determining device for determining a relation between the transmission strength value and the reception strength value.

According to a further embodiment, the information content of the second radio signal may comprise the reception strength value. According to a further embodiment, the information content of the second radio signal may comprise the relation between the transmission strength value and the reception strength value. According to a further embodiment, the access apparatus may comprise a gap calculating device which is designed to calculate a gap value that characterizes a gap between the first transmit/receive device and the second transmit/receive device on the basis of the relation between transmission strength value and reception strength value, said relation being determined by the relation determining device. According to a further embodiment, the second transmit/receive device and the relation determining device may form integral parts of a mobile apparatus. According to a further embodiment, the first transmit/receive device and the relation determining device may form integral parts of an apparatus.

According to a further embodiment, the second transmit/receive device, the relation determining device and the gap calculating device may form integral parts of a mobile apparatus comprising these devices. According to a further embodiment, the information content of the second radio signal may comprise the gap value.

According to another embodiment, a method for determining a distance value which characterizes the gap between a first transmit/receive device and a second transmit/receive device, may have the following steps: -determining a transmission strength value which is correlated to the current transmission field strength of the first transmit/receive device, -transmitting a first radio signal with the aid of the first transmit/receive device, wherein the information content of the first radio signal comprises a transmission strength value, -receiving the first radio signal with the aid of the second transmit/receive device, -determining a reception strength value which is correlated to the reception field strength of the first radio signal that is received at the second transmit/receive device, -determining the relation between reception strength value and transmission strength value, and forming the distance value on the basis of the determined relation between reception strength value and transmission strength value.

According to a further embodiment, the distance value can be generated proportionally in relation to the quotient of reception strength value and transmission strength value. According to a further embodiment, the distance value may assume a value that is proportional to the gap between first transmit/receive device and second transmit/receive device. According to a further embodiment, the distance value may assume a value that classifies the gap between first transmit/receive device and second transmit/receive device.

### BRIEF DESCRIPTION OF THE DRAWINGS

Further features of the invention are derived from the following description of exemplary embodiments, in connection with the claims and the figures. Each of the discrete features can be realized individually or in multiples in the context of an embodiment. In the following explanation of a plurality of exemplary embodiments, reference is made to the appended figures, in which:

FIG. 1 shows a schematic illustration of an access facility which allows determination of the reception field strength relative to the transmission field strength, and

FIG. 2 provides a flow diagram to illustrate the essential steps of the method that is executed by the access facility as per FIG. 1 for determining a gap between the two communication devices of the access facility.

### DETAILED DESCRIPTION

According to various embodiments, an access facility for a vehicle, may have a first transmit/receive device for transmitting a first radio signal and receiving a second radio signal, a second transmit/receive device for transmitting the second radio signal and receiving the first radio signal, a transmission strength determining device for determining a transmission strength value which represents the transmission field strength of the first radio signal transmitted by the first transmit/receive device, and a reception strength determining device for determining a reception strength value which represents the reception field strength of the first radio signal at the location of the second transmit/receive device. In this case, the information content of the first radio signal of the access facility is designed such that it comprises the transmission strength value, and the access facility additionally features a relation determining device for determining a relation between the transmission strength value and the reception strength value.

In this context, it is noted that the terms “comprise”, “feature”, “contain”, “include” and “have”, and their grammatical derivatives, which are used to enumerate features in this description and in the claims, are generally to be regarded as a non-restrictive enumeration of features, e.g. method steps, devices, ranges, variables and the like, and in no way exclude the presence of other or additional features or groups of other or additional features.

According to another embodiment, a method for determining a distance value which characterizes the gap between a first transmit/receive device and a second transmit/receive device, may have steps for determining a transmission strength value which is correlated to the current transmission field strength of the first transmit/receive device, for transmitting a first radio signal with the aid of the first transmit/receive device, wherein the information content of the first radio signal comprises a transmission strength value, for receiving the first radio signal with the aid of the second transmit/receive device, for determining a reception strength value which is correlated to the reception field strength of the first radio signal that is received at the second transmit/receive device, for determining the relation between reception strength value and transmission strength value, and for forming the distance value on the basis of the determined relation between reception strength value and transmission strength value.

According to the various embodiments, it is made possible to determine a variable which characterizes the gap between the first communication device and the second communication device, without any need to regulate or control the transmission field strength of the signal that is emitted by the first communication device. The first communication device can therefore be configured in a simpler and more robust manner, and features a reduced dissipated power.

In the simplest case, the information content of the second radio signal comprises the reception strength value, and therefore the relation determining device can be arranged at the location of the first transmit/receive device.

In order to send a variable which characterizes the gap between the first transmit/receive device and the second transmit/receive device, the information content of the second radio signal preferably comprises the relation between the transmission strength value and the reception strength value. The access control can then be performed by the device which contains the first transmit/receive device.

In order that e.g. specific functions of the access facility can be triggered depending on between the first and the second transmit/receive device, the access facility preferably features a gap calculating device which is designed to calculate a gap value that characterizes a gap between the first transmit/receive device and the second transmit/receive device on the basis of the relation between the transmission strength value and the reception strength value, said relation being determined by the relation determining device.

In order to realize an access facility which has user identification, the second transmit/receive device and the relation determining device advantageously form integral parts of a mobile apparatus that can be carried by a relevant user who is to be identified. Alternatively, the relation determining device and the first transmit/receive device can be arranged together, such that both form integral parts of an apparatus in which they are comprised. In order to avoid a delay in the gap calculation, said delay being caused by splitting the necessary determination processes between spatially separate components of the access facility, the second transmit/receive device, the relation determining device and the gap calculating device form integral parts of a mobile apparatus comprising these devices. In this case, the information content of the second radio signal also comprises the gap value which is calculated thus.

A gap value which is correlated to the gap between first and second transmit/receive device is easily obtained by means of a distance value that is generated proportionally in relation to the quotient of reception strength value and transmission strength value.

A gap value which corresponds linearly to the separation between both communication devices can be obtained by means of a distance value that assumes a value proportional to the gap between first transmit/receive device and second transmit/receive device.

If only specific gap zones are to be detected, the gap value can be generated from a distance value that assumes a value that classifies the gap between first transmit/receive device and second transmit/receive device.

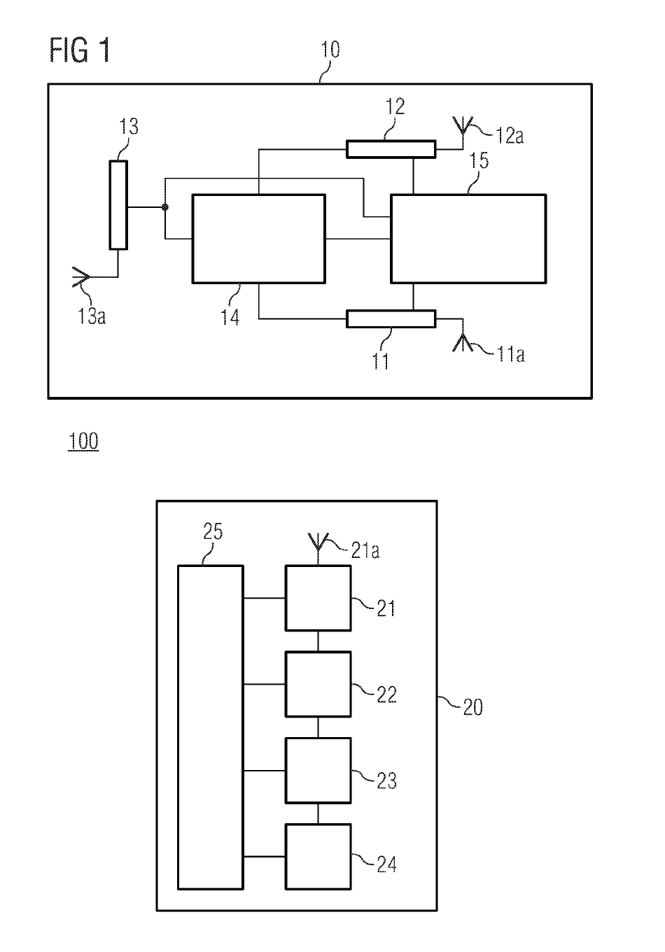

The block diagram in FIG. 1 shows the main components of an access apparatus 100 providing a gap calculation that is based on a relation between transmission field strength and reception field strength of a signal. The access apparatus features a first communication device 10 and a second communication device 20. The access apparatus shown here is preferably used in an access control system of a motor vehicle, but can also be employed in any other access control system, e.g. inside buildings.

The first communication device 10 features a first transmit/receive device, which comprises the three units 11, 12 and 13 with the associated antennas 11a, 12a and 13a in the embodiment illustrated in FIG. 1. Each of these transmit/receive units 11, 12 and 13 is designed to transmit and receive signals with the aid of their allocated antennas 11a, 12a or 13a. The transfer of the signals can take place on a plurality of frequencies. For example, the aforementioned request signal can be transmitted in the inductive kHz range, while other signals of the data transfer between the two communication devices 10 and 20 can be transferred in the MHz range.

The construction of the first transmit/receive device having a plurality of transmit/receive units 11, 12 and 13 makes it possible independently to control the access to a plurality of locking apparatuses of a device, e.g. the locks on driver door, passenger doors and tailgate of a motor vehicle. In the simplest case, e.g. in the case of central locking of a vehicle, the first transmit/receive device only features one transmit/receive unit 11, 12 or 13. If a plurality of transmit/receive units 11, 12 and 13 are used, however, they preferably transmit the request signal in a temporally staggered manner.

The transmission field strength of the broadcast radio signal, e.g. the request signal, is determined by the transmission strength determining device 14. The determination preferably does not take place as a measurement of the actual field strength with which the radio signal was broadcast at the respective antennas 11a, 12a or 13a, but on the basis of a value that is easy to calculate and is directly linked to the transmission field strength. This value is subsequently referred to as transmission strength value. The transmission strength value is preferably directly related to the signal strength, i.e. to the signal voltage or to the signal current at the feeding point of the antenna 11a, 12a or 13a which is currently being used, or at a suitable point of the transmission unit 11, 12 or 13 which is feeding the relevant antenna.

The control device 15 is designed to control the data exchange via the first transmit/receive device. In particular, it controls the regular broadcast of the request signal, checks the reply signal sent by the second transmit/receive device, and determines the access authorization on the basis of the data telegrams that are exchanged with the second communication device.

In order to allow a value to be determined which characterizes the gap between the first and the second communication device, the control device 15 transmits the transmission strength value to the second communication device via the first transmit/receive device. The transmission strength value can already be contained in the request signal, such that the control device 15 can already establish the gap value for the distance between the two communication devices on the basis of the reply signal which is transmitted back by the second communication device.

If the identification of the second communication device, together with the gap value and possibly further characteristic values, result in an access authorization, the control device 15 activates the locking apparatus(es) (not shown in FIG. 1) in such a way that these can be engaged or disengaged according to the parameters or further operating instructions. In this case, the control device 15 can effect the control of the locking apparatuses directly, but it can also transfer corresponding control signals via an interface to a further control device which is arranged outside of the access facility 100, e.g. to the central control device of a motor vehicle.

The second communication device 20 is advantageously arranged inside a mobile device which has small dimensions and which can be carried without great inconvenience by a user in order to provide proof of identification. The second communication device 20 comprises a second transmit/receive device 21 with an antenna 21a, a reception strength determining device 22, a relation determining device 23, a gap calculating device 24 and a control device 25.

The second transmit/receive device 21 is designed to transmit and receive signals via the antenna 21a. The reception of the request signal preferably takes place via an LF unit in the kHz range, while the further exchange of data telegrams takes place via an HF unit in the MHz range.

The second transmit/receive device 21 is connected to a reception strength determining device 22 which determines the reception field strength of the radio signal which is broadcast by the first communication device in each case. As when determining the transmission field strength, the determination here likewise does not take place as a measurement of the actual field strength at the antenna 21a, but again takes place on the basis of a value that is easy to determine and is directly linked to the reception field strength. This value is subsequently referred to as reception strength value. The reception strength value is preferably directly related to the strength of the received radio signal, i.e. to the signal voltage or to the signal current at the feeding point of the antenna 21a or at a suitable point of the receive unit 21 which is processing the antenna signal.

The transmission strength value contained in a signal that is received from the first communication device 10 is forwarded to the relation determining device 23 (either directly or via the control device 25). The relation determining device 23 is designed to determine the relation between the reception strength value and the transmission strength value. The relation is preferably generated in the form of a quotient of the two values. However, other relations are possible, e.g. a difference between transmission strength value and reception strength value normalized over the transmission strength value, which can be expressed in the following form:

$$Relation = \frac{Transmission strength value - Reception strength value}{Transmission strength value} \qquad ( 1 )$$

In contrast with the embodiment shown in FIG. 1, the relation device 23 can also be arranged in the first communication device 10, e.g. within the control device 15. In this case, the second communication device 20 transfers the reception strength value which is determined by the reception strength determining device 22 to the first communication device 10 for further processing. In order to avoid further data transfers which are solely for the purpose of gap value calculation, the gap calculating device 24 described below is preferably constructed inside the first communication device 10 in this case.

The gap calculating device 24 is used for calculating a gap value which is characteristic of a given distance between the first transmit/receive unit and the second transmit/receive unit. The gap value can be produced e.g. by weighting the previously determined relation between transmission strength value and reception strength value. In some cases, however, it is not the exact gap that is of interest, but a positive classification of the gap, said classification making it possible to recognize the current gap situation, e.g. whether the first communication device is situated in the detection zone, the authentication zone or the access zone. For this, the previously determined relation can be compared with predetermined threshold values and a value which characterizes the position of the relation with reference to the threshold values can be specified as a gap value, e.g. 0, 1 or 2 (or de, au, ac or similar) for detection zone, authentication zone or access zone. In the foregoing example, the threshold values do not have to be fixed values, but can be normalized using the current transmission field strength value.

The sequence control of the gap value calculation and the control of the data dialog with the first communication device are handled by the control device 25, which is designed for this purpose. If relation device 23 and/or gap calculating device 24 are arranged in the first communication device 10, the handling of the gap value calculation is divided between both control devices 25 and 15. If the gap value is calculated in the second communication device 20, the control device 25 controls the second transmit/receive device for the purpose of transferring a radio signal containing the gap value.

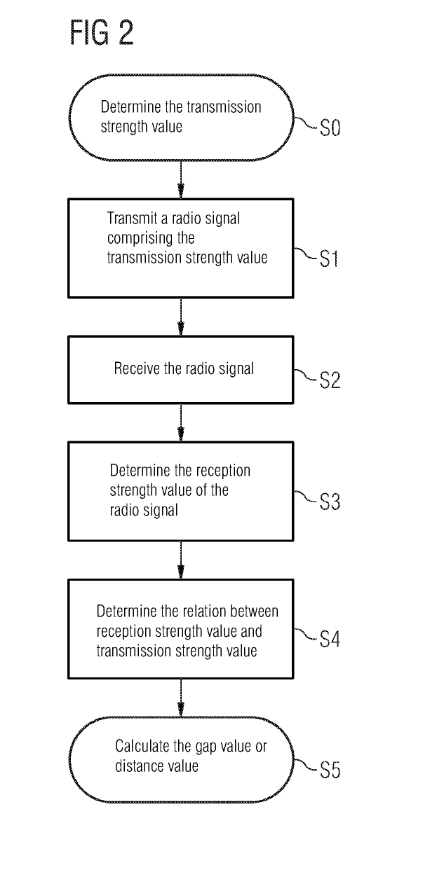

The flow diagram in FIG. 2 shows the main method steps for determining a gap value or distance value which characterizes the gap between the first transmit/receive device and the second transmit/receive device. The method starts in step S0 with the determination of a transmission strength value which, in the manner described above, is correlated to the current transmission field strength of the first transmit/receive device. In step S1, a radio signal whose information content includes the transmission strength value is transferred to the second transmit/receive device 21 by means of the first transmit/receive device. This radio signal is received by the second transmit/receive device 21 in step S2, whereupon the reception strength value is determined by the reception strength determining device 22 in step S3 and, in the manner described above, is correlated to the reception field strength of the radio signal at the second transmit/receive device 21. In step S4, the relation determining device 23 determines the relation between transmission strength value and reception strength value in one of the ways described above, before the gap value or distance value is finally calculated by the gap calculating device 24 in step S5 on the basis of the relation determined thus.

The distance value can be produced by weighting the relation, such that the gap value is always proportional to the relation, this being produced from the quotient of reception strength value and transmission strength value in the simplest case. In other embodiments of the access facility 100, the non-linear decrease of the radio signal strength relative to the remoteness of the first communication device is taken into consideration for the distance value calculation or gap value calculation, such that a gap value or distance value can be achieved which is proportional to a gap between first and second transmit/receive device. Instead of values which are linked continuously to the relation, the gap value or distance value can also assume discrete values as described above, which classify the relevant gap between first and second communication device or between first and second transmit/receive device.

### LIST OF REFERENCE NUMERALS

10 First communication device
11 First unit of the first transmit/receive device
11a Antenna of the first unit of the first transmit/receive device
12 Second unit of the first transmit/receive device
12a Antenna of the second unit of the first transmit/receive device
13 Third unit of the first transmit/receive device
13a Antenna of the third unit of the first transmit/receive device
14 Transmission strength determining device
15 Control device of the first communication device
20 Second communication device
21 Second transmit/receive device
21a Antenna of the second transmit/receive device
22 Reception strength determining device
23 Relation determining device
24 Gap calculating device
25 Control device of the second communication device
100 Access facility

What is claimed is:

1. An access facility for a vehicle, comprising
a first transmit/receive device for transmitting a first radio signal and receiving a second radio signal,
a second transmit/receive device for transmitting the second radio signal and receiving the first radio signal,
a transmission strength determining device for determining a transmission strength value, which represents the transmission field strength of the first radio signal transmitted by the first transmit/receive device, and
a reception strength determining device for determining a second reception strength value, which represents the reception field strength of the first radio signal at the location of the second transmit/receive device, wherein
the information content of the first radio signal comprises the transmission strength value, and the access facility features a relation determining device for determining a relation between the transmission strength value and the reception strength value.

2. The access facility according to claim 1, wherein
the information content of the second radio signal comprises the reception strength value.

3. The access facility according to claim 1,
wherein
the information content of the second radio signal comprises the relation between the transmission strength value and the reception strength value.

4. An access apparatus according to claim 1,
comprising
a gap calculating device which is designed to calculate a gap value that characterizes a gap between the first transmit/receive device and the second transmit/receive device on the basis of the relation between transmission strength value and reception strength value, said relation being determined by the relation determining device.

5. The access apparatus according to claim 1,
wherein
the second transmit/receive device and the relation determining device form integral parts of a mobile apparatus.

6. The access apparatus according to claim 1,
wherein
the first transmit/receive device and the relation determining device form integral parts of an apparatus.

7. The access apparatus according to claim 5,
wherein
the second transmit/receive device the relation determining device and the gap calculating device form integral parts of a mobile apparatus comprising these devices.

8. The access apparatus according to claim 7,
wherein
the information content of the second radio signal comprises the gap value.

9. A method for determining a distance value which characterizes the gap between a first transmit/receive device and a second transmit/receive device, comprising the following steps:
determining a transmission strength value which is correlated to the current transmission field strength of the first transmit/receive device,
transmitting a first radio signal with the aid of the first transmit/receive device, wherein the information content of the first radio signal comprises a transmission strength value,
receiving the first radio signal with the aid of the second transmit/receive device,
determining a reception strength value which is correlated to the reception field strength of the first radio signal that is received at the second transmit/receive device,
determining the relation between reception strength value and transmission strength value, and
forming the distance value on the basis of the determined relation between reception strength value and transmission strength value.

10. The method according to claim 9,
wherein
the distance value is generated proportionally in relation to the quotient of reception strength value and transmission strength value.

11. The method according to claim 9,
wherein
the distance value assumes a value that is proportional to the gap between first transmit/receive device and second transmit/receive device.

12. The method according to claim 9,
wherein
the distance value assumes a value that classifies the gap between first transmit/receive device and second transmit/receive device.

13. A method for determining a distance between two devices, comprising the steps of:
transmitting a first radio signal by a first device wherein an information content of the first radio signal comprises the transmission strength value,
receiving the first radio signal by a second device,
determining a transmission strength value, which represents the transmission field strength of the first radio signal transmitted by the first device,
determining a second reception strength value, which represents the reception field strength of the first radio signal, and
determining a relation between the transmission strength value and the reception strength value.

14. The method according to claim 13,
further comprising transmitting a second radio signal by the second device wherein an information content of the second radio signal comprises the reception strength value.

15. The method according to claim 13,
further comprising transmitting a second radio signal by the second device wherein an information content of the second radio signal comprises the relation between the transmission strength value and the reception strength value.

16. The method according to claim 13,
further comprising the step of calculating a gap value that characterizes a gap between the first device and the second device on the basis of the relation between transmission strength value and reception strength value.

17. The method according to claim 16,
further comprising transmitting a second radio signal by the second device wherein an information content of the second radio signal comprises the gap value.
